(19) United States
(12) Patent Application Publication
(10) Pub. No.: US 2011/0055556 A1
(43) Pub. Date: Mar. 3, 2011

(54) METHOD FOR PROVIDING ANONYMOUS PUBLIC KEY INFRASTRUCTURE AND METHOD FOR PROVIDING SERVICE USING THE SAME

(75) Inventors: Byeong Cheol Choi, Daejeon (KR); So Hee Park, Daejeon (KR); Jeong Nyeo Kim, Daejeon (KR)

(73) Assignee: Electronics and Telecommunications Research Institute, Daejeon (KR)

(21) Appl. No.: 12/674,903

(22) PCT Filed: Jul. 11, 2008
(86) PCT No.: PCT/KR08/04107

§ 371 Date: Mar. 31, 2010

(51) Int. Cl. H04L 9/30

(52) U.S. Cl. 713/156

(57) ABSTRACT

Provided is a method for providing an anonymous public key infrastructure (PKI) in a user terminal. The method includes receiving a real-name certificate from a real-name PKI service domain, requesting an anonymous certificate to an anonymous PKI service domain, and receiving the anonymous certificate from the anonymous PKI service domain. Accordingly, the method can ensure anonymity when a user uses a service by providing the anonymous certificate in association with the PKI-based real-name certificate.

### TECHNICAL FIELD

The present disclosure relates to a method for providing an anonymous public key infrastructure, and more particularly, to a method for providing an anonymous public key infrastructure (PKI), which is capable of ensuring anonymity when a user uses a service by providing an anonymous certificate in association with a PKI-based real-name certificate.

This work was supported by the IT R&D program of MIC/IITA [Work management number: 2007-S-016-01, Work title: A Development of Cost Effective and Large Scale Global Internet Service Solution]

### BACKGROUND ART

With the broad expansion of various fields such as electronic commerce, stock, and document issue via the Internet, methods for identifying users and services are needed. As one method, transaction parties are identified using resident registration numbers, certificates, or a combination thereof.

A public key infrastructure (PKI) is a composite security system environment that provides encryption and digital signature through a public key algorithm. That is, the PKI is a system that encrypts transmit/receive (TX/RX) data using the public key containing an encryption key and a decryption key, and authenticates users through a digital certificate. The PKI is configured to ensure the stability and reliability of electronic commerce or information distribution. The PKI functions to identify users, check the change of information contents, and prohibit disclosure of information.

When electronic commerce is carried out based on a PKI system, a user signs a digital signature for the electronic commerce, receives a certificate of a certification authority, and submits the certificate to an opposite party. In this way, the electronic commerce is achieved. In this case, secure electronic commerce can be obtained because personal information or transaction information is not exposed to the outside. Therefore, the PKI is widely used in various fields, such as electronic payment, digital signature, electronic cash, electronic voting, single sign-on (SSO), web security, e-mail security, remote access, electronic document, and so on.

However, the PKI uses a real-name certificate. Thus, since a personal real name is opened even in security or SSO applications as well as applications of financial institutions legally requiring a real name, user's privacy may be invaded when he/she uses Internet services. In addition, some companies may misuse real-name information.

Therefore, there is a growing need for a method that can protect a user's privacy and issue a PKI-based certificate.

### DISCLOSURE OF INVENTION

### Technical Problem

Therefore, an object of the present invention is to provide a method for providing an anonymous PKI, which is capable of ensuring anonymity when a user uses a service by providing an anonymous certificate in association with a PKI-based real-name certificate.

Another object of the present invention is to provide a method for providing a PKI, which can be applied to a variety of services by using an anonymous certificate in association with a PKI-based real-name PKI.

### Technical Solution

To achieve these and other advantages and in accordance with the purpose(s) of the present invention as embodied and broadly described herein, a method for providing an anonymous public key infrastructure (PKI) in a user terminal in accordance with an aspect of the present invention includes: receiving a real-name certificate from a real-name PKI service domain; requesting an anonymous certificate to an anonymous PKI service domain; and receiving the anonymous certificate from the anonymous PKI service domain.

The real-name certificate may have a format defined by the following equation:

CERT(N):=Sig_{CA}_{_{—}}ₚᵣ(N,N_pu)

where N is a real name of a user, N_pu is a public key corresponding to the user, Sig_{CA}_{_{—}}ₚᵣ is a digital signature using a private key (CA_pr) of the real-name PKI service domain, a symbol:=is a definition, and CERT(N) is a real-name certificate of the user.

The requesting of the anonymous certificate may include: generating an anonymous ID; and requesting a user authentication and the anonymous certificate to the anonymous PKI service domain, based on the anonymous ID.

To achieve these and other advantages and in accordance with the purpose(s) of the present invention, a method for providing an anonymous public key infrastructure (PKI) in an anonymous PKI service domain in accordance with another aspect of the present invention includes: receiving a request to issue an anonymous certificate, based on a real-name certificate from a user terminal; requesting a user authentication to a real-name PKI service domain in response to the request to issue the anonymous certificate; receiving a response to the user authentication from the real-name PKI service domain; generating the anonymous certificate, based on the response; and sending the generated anonymous certificate to the user terminal.

To achieve these and other advantages and in accordance with the purpose(s) of the present invention, a method for providing an anonymous service using an anonymous public key infrastructure (PKI) in a service provider in accordance with another aspect of the present invention includes: receiving a request to provide an anonymous service from a user terminal by using an anonymous certificate generated through the method of the present invention; receiving authentication information from an anonymous PKI service domain in response to the request to provide the anonymous service; and providing a service corresponding to the request to provide the anonymous service, based on the authentication information.

The request to provide the anonymous service may have a format defined by the following equation:

K^{ISP}^{_{—}}^{Pu} mod n∥E_{K}(M∥H(M)∥Sig_{A}_{_{—}}ₚᵣ(H(M)))

where K is a shared key between a user of the user terminal and the service provider, ISP_pu is a public key of the service provider, M is a service-providing message, E_{K} is an encryption routine based on the shared key K, H is a hash routine, A_pr is a private key of an anonymous ID corresponding to the anonymous certificate, Sig_{A}_{_{—}}ₚᵣ is a digital signature using a private key CA_pr corresponding to the anonymous ID, mod n is a modular n operation, and // is a concatenation operator.

The receiving of the request to provide the anonymous service may include verifying the request to provide the anonymous service.

### ADVANTAGEOUS EFFECTS

According to the present invention, when a user uses a service, anonymity can be ensured by providing an anonymous certificate in association with a PKI-based real-name certificate.

### BRIEF DESCRIPTION OF THE DRAWINGS

FIG. 1 is an exemplary conceptual diagram illustrating a method for providing an anonymous PKI according to an embodiment of the present invention.

FIG. 2 is an exemplary conceptual diagram illustrating a method for providing an anonymous service according to an embodiment of the present invention.

### BEST MODE FOR CARRYING OUT THE INVENTION

Hereinafter, specific embodiments will be described in detail with reference to the accompanying drawings

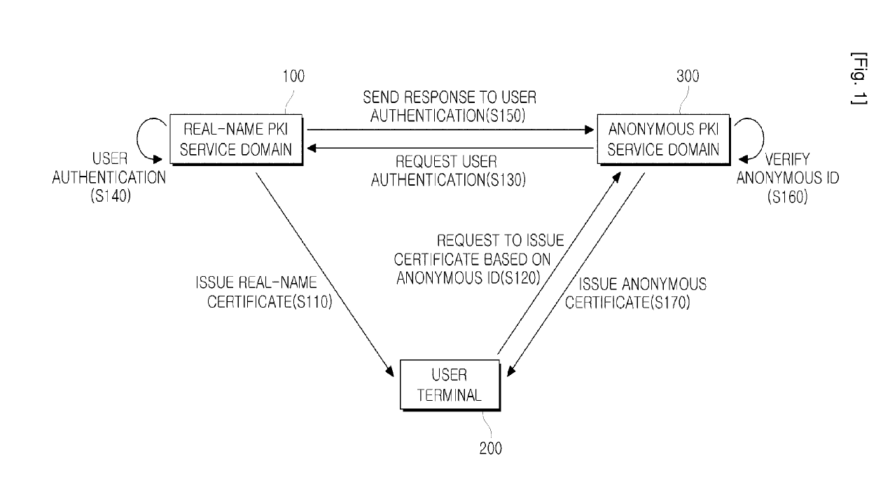

FIG. 1 is an exemplary conceptual diagram illustrating a method for providing an anonymous PKI according to an embodiment of the present invention.

Referring to FIG. 1, the method for providing the anonymous PKI according to the embodiment of the present invention includes a real-name PKI service domain 100, a user terminal 200, and an anonymous PKI service domain 300.

The real-name PKI service domain 100 is a server that includes a certification authority and a certification authority repository, and issues and stores a real-name certificate.

The anonymous PKI service domain 300 is a server that includes a pseudonym certification authority and a pseudonym certification authority repository, and issues and stores an anonymous certificate.

The user terminal 200 stores and uses the real-name certificate and the anonymous certificate.

The method for providing the anonymous PKI according to the embodiment of the present invention will be described below in detail.

In operation S110, the real-name PKI service domain 100 issues a real-name certificate in response to a request from the user terminal 200 and transfers the issued real-name certificate to the user terminal 200, and the user terminal 200 receives the real-name certificate.

The real-name certificate issued by the real-name PKI service domain 100 has a format defined by Equation (1) below.

CERT(N):=Sig_{CA}_{_{—}}ₚᵣ(N,N_pu) (1)

where N is a real name of a user, N_pu is a public key corresponding to the user, Sig_{CA}_{_{—}}ₚᵣ is a digital signature using a private key (CA_pr) of the real-name PKI service domain 100, a symbol:=is a definition, and CERT(N) is a real-name certificate of the user.

That is, the user of the user terminal 200 receives the real-name certificate issued from the real-name PKI service domain 100 based on information on the real name N.

In operation S120, the user terminal 200 requests the anonymous PKI service domain 300 to issue the anonymous certificate. In this case, the user terminal 200 and the anonymous PKI service domain 300 can exchange anonymous ID in order for issuing the anonymous certificate.

That is, the user terminal 200 can generate the anonymous ID through the information exchange with the anonymous PKI service domain 300, and request user authentication and the anonymous certificate to the anonymous PKI service domain 300, based on the generated anonymous ID.

The anonymous ID can be generated through a Diffie-Hellman (DH) key exchange or ECC key exchange between the user terminal 200 and the anonymous PKI service domain 300. The user terminal 200 and the anonymous PKI service domain 300 can generate a reliable anonymous ID through the DH key exchange or ECC key exchange, while not opening their secret information.

The anonymous ID based on the DH key exchange may have a format defined by Equation (2) or (3) below.

AID:=(g^{PCA}^{_{—}}^{pr})^{A}^{_{—}}^{pr} mod n (2)

AID:=(g^{A}^{_{—}}^{pr})^{PCA}^{_{—}}^{pr} mod n (3)

where PCA_pr is a private key of the anonymous PKI service domain 300, A_pr is a private key corresponding to the anonymous ID, mod n is a modular n operation, g is a password generator, a symbol:=is a definition, and AID is the anonymous ID.

The generation of the anonymous ID is performed at the user terminal 200 and the anonymous PKI service domain 300. Therefore, one of the Equations (2) and (3) is the anonymous ID generated by the user terminal 200, and the other is the anonymous ID generated by the anonymous PKI service domain 300. These anonymous IDs may be verified later in operation S160.

The anonymous ID based on the ECC key exchange may have a format defined by Equation (4) or (5) below.

AID:=A_pr(PCA_pr(G))mod n (4)

AID:=PCA_pr(A_pr(G))mod n (5)

where PCA_pr is a private key of the anonymous PKI service domain 300, A_pr is a private key corresponding to the anonymous ID, mod n is a modular n operation, g is a password generator, a symbol:=is a definition, and AID is the anonymous ID.

The generation of the anonymous ID is performed at the user terminal 200 and the anonymous PKI service domain 300. Therefore, one of the Equations (2) and (3) is the anonymous ID generated by the user terminal 200, and the other is the anonymous ID generated by the anonymous PKI service domain 300. These anonymous IDs may be verified later in operation S160.

Meanwhile, in this case, information for user authentication may be sent together in order for issuing the anonymous certificate.

That is, the request sent from the user terminal 200 to the anonymous PKI service domain 300 in order for issuing the anonymous certificate may contain a message having a format defined by Equation (6) below.

(K^{CA}^{_{—}}^{pu} mod n∥E_{K}(CERT(N)))∥(AID∥A_{—}pu) (6)

where K is a secret key, CA_pu is a public key of the real-name PKI service domain 100, mod n is a modular n operation, // is a concatenation operator, E_{K} is an encryption routine using the secret key K, CERT(N) is the real-name certificate, AID is the anonymous ID, and A_pu is the public key corresponding to the anonymous ID.

When the anonymous PKI service domain 300 receives the request to issue the anonymous certificate, it sends a user authentication request to the real-name PKI service domain 100 in operation S130. This user authentication request is referred to as a secondary user authentication in order to differentiate the user authentication sent from the user terminal 200 to the anonymous PKI service domain 300.

In this case, the secondary user authentication request may be performed by sending a message defined by Equation (7) below.

K^{CA}^{_{—}}^{pu} mod n∥E_{K}(CERT(N)) (7)

where K is a secret key, CA_pu is a public key of the real-name PKI service domain 100, mod n is a modular n operation, // is a concatenation operator, E_{K} is an encryption routine using the secret key K, and CERT(N) is the real-name certificate.

When the real-name PKI service domain 100 receives the secondary user authentication request sent in operation S130, it performs the user authentication through an internal verification routine in operation S140. In particular, CERT(N) is extracted by decrypting E_{K}(CERT(N)) and then compared with the real-name certificate stored by itself.

This process may be expressed as Equation (8) below.

CERT(N)=?D_{K}(E_{K}(CERT(N))) (8)

where D_{K} is a decryption routine using a secret key K, and a symbol=? is an operation that is performed for comparing if both sides are identical to each other.

When the user authentication is finished in operation S140, the corresponding response is sent to the anonymous PKI service domain 300 in operation S150.

The response is information indicating if the user authentication with respect to the secondary user authentication succeeds or fails.

Thereafter, the anonymous PKI service domain 300 issues the anonymous certificate, based on the response sent in operation S150, and sends the issued anonymous certificate to the user terminal 200 in operation S170.

Before issuing the anonymous certificate, the verification of the anonymous ID may be performed in operation S160.

That is, the verification of the anonymous ID is performed as expressed in Equation (9) below.

AID_{PCA}=?AID_{N} (9)

where AID_{PCA} is the anonymous ID stored in the anonymous PKI service domain 300, AID_{N} is the anonymous ID generated from the user terminal 200 and sent to the anonymous PKI service domain 300, and a symbol=? is an operation that is performed for comparing if both sides are identical to each other.

That is, the identity of the anonymous IDs generated in pair as expressed in Equation (2) or (3) or Equation (4) or (5) is verified.

The user terminal 200 receives the anonymous certificate from the anonymous PKI service domain 300 and can use the received anonymous certificate in operation S170.

Meanwhile, the anonymous certificate may have a format defined by Equation (10) below.

ACERT(AID):=Sig_{PCA}_{_{—}}ₚᵣ(AID,A_pu) (10)

where AID is the anonymous ID, A_pu is the public key corresponding to the anonymous ID, Sig_{PCA}_{_{—}}ₚᵣ is the digital signature using the private key PCA pr of the anonymous PKI service domain 300, a symbol:=is a definition, and ACERT(AID) is the anonymous certificate of the user.

In this way, when the anonymous certificate is issued, the user can receive the service requiring the authentication, without exposing his/her privacy.

A method for providing a service using the anonymous certificate will be described in detail.

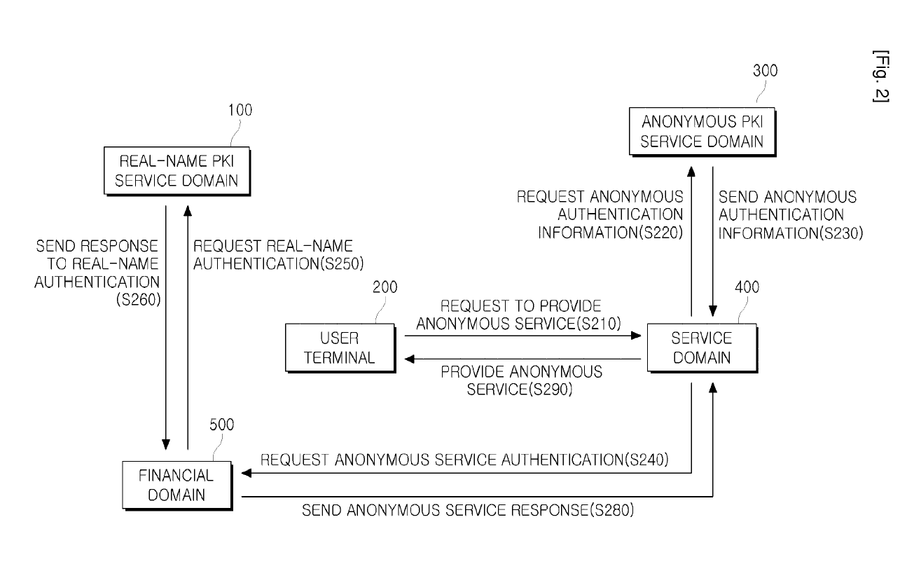

FIG. 2 is an exemplary conceptual diagram illustrating a method for providing an anonymous service according to an embodiment of the present invention.

As illustrated in FIG. 2, the method for providing the anonymous service according to the embodiment of the present invention can be exemplarily applied within a system including a real-name PKI service domain 100, a user terminal 200, an anonymous PKI service domain 300, a service domain 400, a financial domain 500.

The service domain 400 is a server of a company that provides a service based on a certificate. For example, the service domain 400 may be a server of an Internet service provider (ISP).

The financial domain 500 is a server of a financial institution, such as a card company or bank, which performs a financial transaction. That is, the financial domain 500 is a server requiring real-name information.

In operation S210, the user terminal 200 requests the service domain 400 to provide an anonymous service by using the anonymous certificate provided with reference to FIG. 1.

In this case, the request to provide the anonymous service may have a format defined by Equation (11) below.

K^{ISP}^{_{—}}^{pu} mod n∥E_{K}(M∥H(M)∥Sig_{A}_{_{—}}ₚᵣ(H(M))) (11)

where K is a shared key between the user of the user terminal 200 and the service domain 400, ISP_pu is a public key of the service domain 400, M is a service-providing message, E_{K} is an encryption routine based on the shared key K, H is a hash routine, A_pr is a private key of the anonymous ID corresponding to the anonymous certificate, Sig_{A}_{_{—}}ₚᵣ is a digital signature using a private key CA_pr corresponding to the anonymous ID, mod n is a modular n operation, and // is a concatenation operator.

Like this, the request to provide the anonymous service does not contain the real-name information.

Meanwhile, when the service domain 400 receives the request to provide the anonymous service in operation S210, it can verify the request to provide the anonymous service. This verification process may include checking if there is an error in the message format. Also, this verification process may include requesting anonymous authentication information to the anonymous PKI service domain 300.

In operation S220, the service domain 400 requests the authentication information to the anonymous PKI service domain 300 in response to the request to provide the anonymous service in operation S210. In operation S230, the service domain 400 receives the authentication information from the anonymous PKI service domain 300.

In this case, the authentication information received from the anonymous PKI service domain 300 may contain the anonymous ID corresponding to the anonymous certificate and the encryption value E_{K}(CERT(N)) of the real-name certificate CERT(N) corresponding to the anonymous certificate.

Even in this case, since the encrypted real-name certificate CERT(N) is sent, it is not exposed to external attacks.

In operation S290, the service domain 400 provides a service corresponding to the request to provide the anonymous service in operation S210, based on the authentication information received in operation S230.

In this case, the service can be provided only through the anonymous authentication.

However, if the real-name authentication is needed, a real-name authentication must be performed prior to operation S290.

For example, upon financial transaction, the financial domain 500 must check the real-name information.

To this end, the service domain 400 may send a real-name authentication request to the financial domain 500 with respect to the anonymous service in operation S240.

For example, the real-name authentication request may contain the anonymous ID, the service-providing message M, and encryption value E_{K}(CERT(N)).

In this case, in operations S250 and S260, the financial domain 500 receives a response to the real-name authentication through communication with the real-name PKI service domain 100, based on the received real-name authentication request.

In operation S280, the financial domain 500 sends a response to the real-name authentication request of operation S240.

For example, a response format may be constructed with the anonymous ID, the service-providing message M, and an authentication acknowledge (ACK) with respect to the service-providing message M.

If the service domain 400 receives the response, it can provide the service without checking the real-name information, even when the real-name authentication is needed.

Therefore, the probability of user's privacy exposure can be minimized.

While the invention has been shown and described with reference to certain preferred embodiments thereof, it will be understood by those skilled in the art that various changes in form and details may be made therein without departing from the spirit and scope of the invention as defined by the appended claims.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

### INDUSTRIAL APPLICABILITY

As described above, the method for providing the anonymous PKI according to the present invention can ensure anonymity when a user uses a service by providing the anonymous certificate in association with the PKI-based real-name certificate. For example, when the user uses services related to electronic commerce, such as electronic payment, digital signature, electronic cash, electronic voting, and SSO, the user's privacy can be protected because the anonymity is ensured.

1. A method for providing an anonymous public key infrastructure (PKI) in a user terminal, the method comprising:
receiving a real-name certificate from a real-name PKI service domain;
requesting an anonymous certificate to an anonymous PKI service domain; and
receiving the anonymous certificate from the anonymous PKI service domain.

2. The method of claim 1, wherein the real-name certificate has a format defined by the following equation:
CERT(N):=Sig_{CA}_{_{—}}ₚᵣ(N,N_pu)
where N is a real name of a user, N_pu is a public key corresponding to the user, Sig_{CA}_{_{—}}ₚᵣ is a digital signature using a private key (CA_pr) of the real-name PKI service domain, a symbol:=is a definition, and CERT(N) is a real-name certificate of the user.

3. The method of claim 1, wherein the requesting of the anonymous certificate comprises:
generating an anonymous ID; and
requesting a user authentication and the anonymous certificate to the anonymous PKI service domain, based on the anonymous ID.

4. The method of claim 3, wherein the anonymous ID has a format defined by the following equation:
AID:=(g^{PCA}^{_{—}}^{pr})^{A}^{_{—}}^{pr} mod n, or
AID:=(g^{A}^{_{—}}^{pr})^{PCA}^{_{—}}^{pr} mod n
where PCA_pr is a private key of the anonymous PKI service domain, A_pr is a private key corresponding to the anonymous ID, mod n is a modular n operation, g is a password generator, a symbol:=is a definition, and AID is the anonymous ID.

5. The method of claim 3, wherein the anonymous ID has a format defined by the following equation:
AID:=A_{—}pr(PCA_pr(G))mod n, or
AID:=PCA_pr(A_pr(G))mod n
where PCA_pr is a private key of the anonymous PKI service domain, A_pr is a private key corresponding to the anonymous ID, mod n is a modular n operation, g is a password generator, a symbol:=is a definition, and AID is the anonymous ID.

6. The method of claim 3, wherein a message defined by the following equation is sent to the anonymous PKI service domain in order for the user authentication request
(K^{CA}^{_{—}}^{pu} mod n∥E_{K}(CERT(N)))∥(AID∥A_{—}pu)
where K is a secret key, CA_pu is a public key of the real-name PKI service domain, mod n is a modular n operation, // is a concatenation operator, E_{K} is an encryption routine using the secret key K, CERT(N) is the real-name certificate, AID is the anonymous ID, and A_pu is the public key corresponding to the anonymous ID.

7. The method of claim 6, wherein the anonymous PKI service domain requests a secondary user authentication to the real-name PKI service domain in response to the user authentication request.

8. The method of claim 7, wherein the secondary user authentication is performed by sending a message defined by the following equation to the real-name PKI domain service in order for user authentication request
K^{CA}^{_{—}}^{pu} mod n∥E_{K}(CERT(N))

9. The method of claim 8, wherein the real-name PKI service domain performs the user authentication requested by the anonymous PKI service domain in response to the secondary user authentication, based on the following equation:
CERT(N)=?D_{K}(E_{K}(CERT(N)))
where D_{K} is a decryption routine using the secret key K, and a symbol=? is an operation that is performed for comparing if both sides are identical to each other.

10. The method of claim 9, wherein the real-name PKI service domain sends a response to the secondary user authentication to the anonymous PKI service domain.

11. The method of claim 10, wherein the anonymous PKI service domain generates the anonymous certificate, based on the response to the secondary user authentication.

12. The method of claim 11, wherein the anonymous PKI domain service authenticates a validity of the anonymous ID, based on the following equation:
AID_{PCA}=?AID_{N}
where AID_{PCA} is the anonymous ID stored in the anonymous PKI service domain, AID_{N} is the anonymous ID generated from the user terminal, and a symbol=? is an operation that is performed for comparing if both sides are identical to each other.

13. The method of claim 1, wherein the anonymous certificate has a format defined by the following equation:
ACERT(AID):=Sig_{PCA}_{_{—}}ₚᵣ(AID,A_pu)
where AID is an anonymous ID, A_pu is a public key corresponding to the anonymous ID, Sig_{PCA}_{_{—}}ₚᵣ is a digital signature using the private key PCA_pr of the anonymous PKI service domain, a symbol:=is a definition, and ACERT(AID) is the anonymous certificate of the user.

14. The method of claim 3, wherein the anonymous ID is generated through a Diffie-Hellman key exchange or ECC key exchange between the user terminal and the anonymous PKI service domain.

15. A method for providing an anonymous public key infrastructure (PKI) in an anonymous PKI service domain, the method comprising:
receiving a request to issue an anonymous certificate, based on a real-name certificate from a user terminal;
requesting a user authentication to a real-name PKI service domain in response to the request to issue the anonymous certificate;
receiving a response to the user authentication from the real-name PKI service domain;
generating the anonymous certificate, based on the response; and
sending the generated anonymous certificate to the user terminal.

16. The method of claim 15, wherein the receiving of the request to issue the anonymous certificate comprises receiving a request to issue the anonymous certificate, based on an anonymous ID.

17. A method for providing an anonymous service using an anonymous public key infrastructure (PKI) in a service provider, the method comprising:
receiving a request to provide an anonymous service from a user terminal by using an anonymous certificate generated through the method of any one of claims 1 through 16;
receiving authentication information from an anonymous PKI service domain in response to the request to provide the anonymous service; and
providing a service corresponding to the request to provide the anonymous service, based on the authentication information.

18. The method of claim 17, wherein the request to provide the anonymous service has a format defined by the following equation:
K^{ISP}^{_{—}}^{Pu} mod n∥E_{K}(M∥H(M)∥Sig_{A}_{_{—}}ₚᵣ(H(M)))
where K is a shared key between a user of the user terminal and the service provider, ISP_pu is a public key of the service provider, M is a service-providing message, E_{K} is an encryption routine based on the shared key K, H is a hash routine, A_pr is a private key of an anonymous ID corresponding to the anonymous certificate, Sig_{A}_{_{—}}ₚᵣ is a digital signature using a private key CA_pr corresponding to the anonymous ID, mod n is a modular n operation, and // is a concatenation operator.

19. The method of claim 17, wherein the receiving of the request to provide the anonymous service comprises verifying the request to provide the anonymous service.

20. The method of claim 17, wherein the receiving of the authentication information from the anonymous PKI service domain comprises receiving the authentication information including an anonymous ID corresponding to the anonymous certificate and an encryption value (E_{K}(CERT(N))) of the real-name certificate (CERT(N)) corresponding to the anonymous certificate.

21. The method of claim 17, wherein the providing of the service corresponding to the request to provide the anonymous service comprises:
requesting a real-name authentication corresponding to the anonymous certificate; and
receiving a response to the real-name authentication.

22. The method of claim 21, wherein the real-name authentication request comprises the anonymous ID, the service-providing message (M), and the encryption value (E_{K}(CERT(N))).

23. The method of claim 21, wherein the response to the real-name authentication request comprises the anonymous ID, the service-providing message (M), and an authentication acknowledge (ACK) with respec to the service-providing message (M).
